(19) United States
(12) Patent Application Publication
(10) Pub. No.: US 2023/0385902 A1
(43) Pub. Date: Nov. 30, 2023

(54) MANAGEMENT APPARATUS, TERMINAL, AND MANAGEMENT METHOD

(71) Applicant: NEC Corporation, Tokyo (JP)

(72) Inventors: Keita Uchida, Tokyo (JP); Akihiko Ishii, Tokyo (JP)

(73) Assignee: NEC Corporation, Tokyo (JP)

(21) Appl. No.: 18/123,692

(22) Filed: Mar. 20, 2023

(30) Foreign Application Priority Data
May 30, 2022 (JP) 2022-087449

(51) Int. Cl. G06Q 30/0601

(52) U.S. Cl. CPC G06Q 30/0631

(57) ABSTRACT

For a customer to use a purchase history of the customer in order to purchase a product in a store, a management apparatus 101 includes a product acquisition unit 121, a history acquisition unit 122, and a history transmission unit 123. The product acquisition unit 121 acquires, from a terminal 102 of a portable type being operated by a customer in a store, customer identification information for identifying the customer and product identification information about an intended purchase product of the customer. The history acquisition unit 122 acquires a purchase history of an associated product being a product associated with the intended purchase product among purchase histories of the customer, based on purchase history information indicating a purchase history of a product by customer. The history transmission unit 123 transmits a purchase history of the associated product to the terminal 102.

### TECHNICAL FIELD

The present invention relates to a management apparatus, a terminal, a management method and the like.

### BACKGROUND ART

Various techniques for using, for a product purchase of a customer, a history in which the customer purchases a product have been recently proposed.

For example, PTL 1 (International Publication No. WO2021/079720) describes a technique for using, in a product purchase based on electronic commerce by the same customer, information about a product purchase list having settlement completed. In the technique described in PTL 1, a customer who uses a portable terminal refers to a purchase history list, and selects a detail display button associated with a purchase history desired to be referred in current electronic commerce. In this case, a management server described in PTL 1 displays, on a portable terminal 3, a detail screen of a purchase history associated with the selected detail display button.

For example, PTL 2 (Japanese Patent Application Publication No. 2002-269380) describes that, when a purchaser selects a product in a shop, the purchaser acquires, from a purchaser product purchase information management server (hereinafter, also simply referred to as a “management server”), product purchase information such as a previous purchase price, a date, and a residual quantity of a product intended to be purchased, by using a communication function of a portable terminal. PTL 2 describes that the purchaser can more efficiently perform a purchase by making a decision from the information from various angles.

### SUMMARY

In the technique described in PTL 1, even when a customer can use a purchase history of the customer in order to purchase a product in electronic commerce, it is difficult to use the purchase history of the customer in order to purchase a product in a store.

In the technique described in PTL 2, a portable terminal acquires a history of product purchase information about all products purchased by a purchaser. As described in PTL 2, with many pieces of product purchase information and the like even when the product purchase information is arranged by date, a store name, and the like, it may be difficult to find previous product purchase information about a product intended to be purchased at a time for selecting a product in a store. In such a case, it is difficult to use a purchase history of the customer in order to purchase a product in a store.

One example of an object of the present invention is, in view of the problem described above, to provide a management apparatus, a terminal, a management method and the like that solve a challenge to use a purchase history of a customer for the customer to purchase a product in a store.

One aspect of the present invention provides a management apparatus including: a product acquisition means for acquiring, from a terminal of a portable type being operated by a customer in a store, customer identification information for identifying the customer and product identification information about an intended purchase product of the customer;
a history acquisition means for acquiring a purchase history of an associated product being a product associated with the intended purchase product among purchase histories of the customer, based on purchase history information indicating a purchase history of a product by customer; and
a history transmission means for transmitting a purchase history of the associated product to the terminal.

One aspect of the present invention provides a terminal of a portable type being operated by a customer in a store, the terminal including:
a first terminal acquisition means for acquiring customer identification information for identifying the customer;
a second terminal acquisition means for acquiring product identification information about an intended purchase product of the customer;
a terminal transmission means for transmitting the customer identification information and the product identification information to a management apparatus;
a history reception means for receiving, from the management apparatus, a purchase history of an associated product being a product associated with the intended purchase product among purchase histories of the customer; and
a display control means for displaying a purchase history of the associated product on a display means.

One aspect of the present invention provides a management method including,
by a computer:
acquiring, from a terminal of a portable type being operated by a customer in a store, customer identification information for identifying the customer and product identification information about an intended purchase product of the customer;
acquiring a purchase history of an associated product being a product associated with the intended purchase product among purchase histories of the customer, based on purchase history information indicating a purchase history of a product by customer; and
transmitting a purchase history of the associated product to the terminal.

One aspect of the present invention provides a terminal processing method including,
by a computer of a portable type being operated by a customer in a store:
acquiring customer identification information for identifying the customer;
acquiring product identification information about an intended purchase product of the customer;
transmitting the customer identification information and the product identification information to a management apparatus;
receiving, from the management apparatus, a purchase history of an associated product being a product associated with the intended purchase product among purchase histories of the customer; and
displaying a purchase history of the associated product on a display means.

One aspect of the present invention provides a non-transitory computer-readable medium storing a program for causing a computer to execute:
acquiring, from a terminal of a portable type being operated by a customer in a store, customer identification information for identifying the customer and product identification information about an intended purchase product of the customer;
acquiring a purchase history of an associated product being a product associated with the intended purchase product among purchase histories of the customer, based on purchase history information indicating a purchase history of a product by customer; and
transmitting a purchase history of the associated product to the terminal.

One aspect of the present invention provides a program for causing a computer of a portable type being operated by a customer in a store to execute:
acquiring customer identification information for identifying the customer;
acquiring product identification information about an intended purchase product of the customer;
transmitting the customer identification information and the product identification information to a management apparatus;
receiving, from the management apparatus, a purchase history of an associated product being a product associated with the intended purchase product among purchase histories of the customer; and
displaying a purchase history of the associated product on a display means.

According to one aspect of the present invention, a customer can use a purchase history of the customer in order to purchase a product in a store.

### BRIEF DESCRIPTION OF THE DRAWINGS

FIG. 1 is a diagram illustrating an outline of a purchase history management system according to one example embodiment.

FIG. 2 is a diagram illustrating an outline of a functional configuration of a management apparatus according to one example embodiment.

FIG. 3 is a diagram illustrating an outline of a functional configuration of a terminal according to one example embodiment.

FIG. 4 is a flowchart illustrating an outline of management processing according to one example embodiment.

FIG. 5 is a flowchart illustrating an outline of terminal processing according to one example embodiment.

FIG. 6 is a diagram illustrating a functional configuration example of the management apparatus according to one example embodiment.

FIG. 7 is a diagram illustrating a configuration example of one piece of product information.

FIG. 8 is a diagram illustrating a configuration example of one piece of setting information.

FIG. 9 is a diagram illustrating a configuration example of one piece of purchase history information.

FIG. 10 is a diagram illustrating a functional configuration example of a history transmission unit according to one example embodiment.

FIG. 11 is a diagram illustrating a functional configuration example of the terminal according to one example embodiment.

FIG. 12 is a diagram illustrating a physical configuration example of the management apparatus according to one example embodiment.

FIG. 13 is a diagram illustrating a physical configuration example of the terminal according to one example embodiment.

FIG. 14 is a flowchart illustrating one example of purchase history management processing according to one example embodiment.

FIG. 15 is a flowchart illustrating one example of the purchase history management processing according to one example embodiment.

FIG. 16 is a flowchart illustrating one example of the purchase history management processing according to one example embodiment.

FIG. 17 is a diagram illustrating one example of a first screen being a screen for displaying intended purchase product information and a purchase history of an associated product.

FIG. 18 is a diagram illustrating one example of a second screen being a screen for displaying a purchase history of a simultaneous purchase product.

FIG. 19 is a diagram illustrating a functional configuration example of a display control unit according to a modification example 1.

### EXAMPLE EMBODIMENT

Hereinafter, example embodiments of the present invention will be described with reference to the drawings. Note that, in all of the drawings, a similar component has a similar reference sign, and description thereof will be appropriately omitted.

### (Outline)

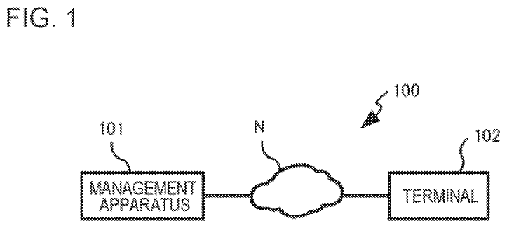

FIG. 1 is a diagram illustrating an outline of a purchase history management system 100 according to one example embodiment. The purchase history management system 100 includes a management apparatus 101 and a terminal 102. The management apparatus 101 and the terminal 102 are connected to each other via a network N. The network N is a communication line constituted in a wired manner, a wireless manner, or a combination of the manners. In this way, the management apparatus 101 and the terminal 102 transmit and receive information to each other via the communication network N.

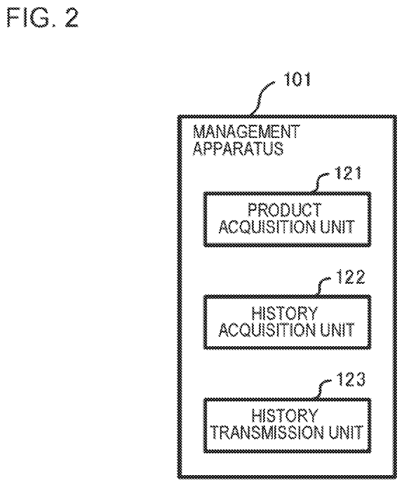

FIG. 2 is a diagram illustrating an outline of a functional configuration of the management apparatus 101 according to one example embodiment. The management apparatus 101 includes a product acquisition unit 121, a history acquisition unit 122, and a history transmission unit 123.

The product acquisition unit 121 acquires, from the terminal 102 of a portable type being operated by a customer in a store, customer identification information for identifying the customer and product identification information about an intended purchase product of the customer.

The history acquisition unit 122 acquires a purchase history of an associated product being a product associated with the intended purchase product among purchase histories of the customer, based on purchase history information indicating a purchase history of a product by customer. The history transmission unit 123 transmits the purchase history of the associated product to the terminal 102.

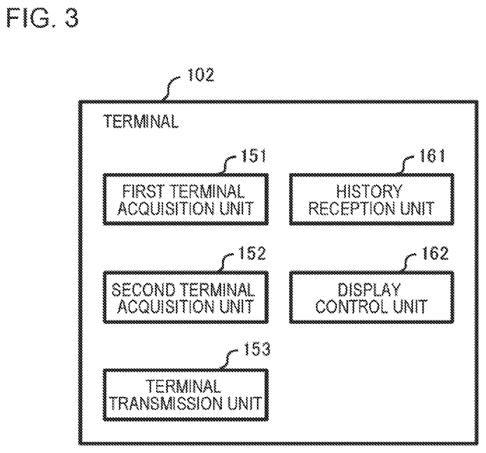

FIG. 3 is a diagram illustrating an outline of a functional configuration of the terminal 102 according to one example embodiment. The terminal 102 is a portable terminal being operated by a customer in a store. The terminal 102 includes a first terminal acquisition unit 151, a second terminal acquisition unit 152, a terminal transmission unit 153, a history reception unit 161, and a display control unit 162.

The first terminal acquisition unit 151 acquires customer identification information for identifying a customer. The second terminal acquisition unit 152 acquires product identification information about an intended purchase product of the customer. The terminal transmission unit 153 transmits the customer identification information and the product identification information to the management apparatus 101.

The history reception unit 161 receives, from the management apparatus 101, a purchase history of an associated product being a product associated with the intended purchase product among purchase histories of the customer. The display control unit 162 displays the purchase history of the associated product on a display unit.

With the purchase history management system 100, a customer can use a purchase history of the customer in order to purchase a product in a store. With the management apparatus 101, a customer can use a purchase history of the customer in order to purchase a product in a store. With the terminal 102, a customer can use a purchase history of the customer in order to purchase a product in a store.

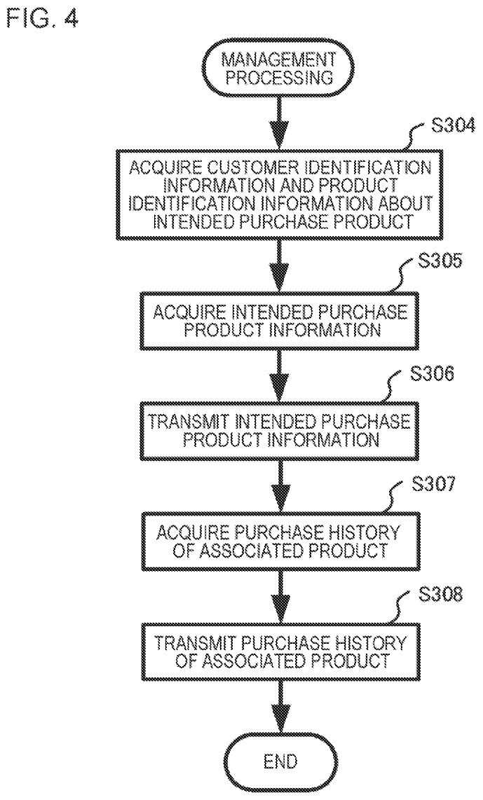

FIG. 4 is a flowchart illustrating an outline of management processing according to one example embodiment.

The product acquisition unit 121 acquires, from the terminal 102 of a portable type being operated by a customer in a store, customer identification information for identifying the customer and product identification information about an intended purchase product of the customer (step S304).

The history acquisition unit 122 acquires a purchase history of an associated product being a product associated with the intended purchase product among purchase histories of the customer, based on purchase history information indicating a purchase history of a product by customer (step S307). The history transmission unit 123 transmit the purchase history of the associated product to the terminal 102 (step S308).

With the management processing, a customer can use a purchase history of the customer in order to purchase a product in a store.

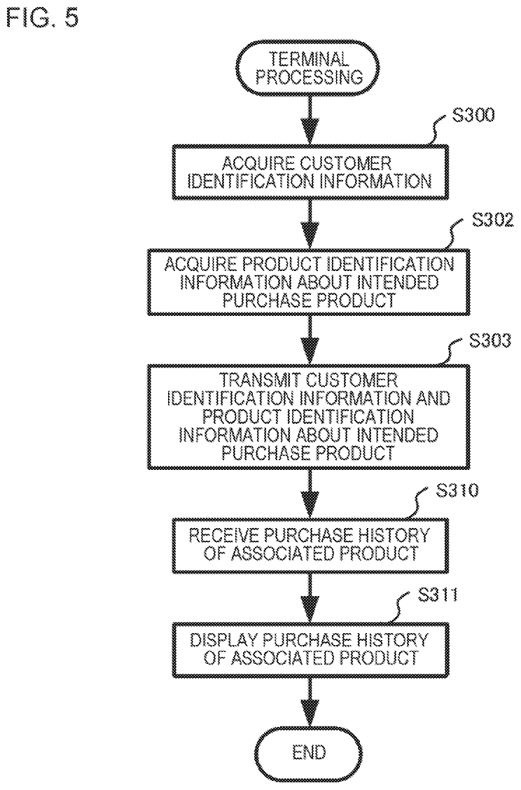

FIG. 5 is a flowchart illustrating an outline of terminal processing according to one example embodiment.

The first terminal acquisition unit 151 acquires customer identification information for identifying a customer (step S300). The second terminal acquisition unit 152 acquires product identification information about an intended purchase product of the customer (step S302). The terminal transmission unit 153 transmits the customer identification information and the product identification information to the management apparatus 101 (step S303).

The history reception unit 161 receives, from the management apparatus 101, a purchase history of an associated product being a product associated with the intended purchase product among purchase histories of the customer (step S310). The display control unit 162 displays the purchase history of the associated product on the display unit (step S311).

With the terminal processing, a customer can use a purchase history of the customer in order to purchase a product in a store.

A detailed example of the purchase history management system 100 according to one example embodiment will be described below.

### Detailed Example

The purchase history management system 100 is a system for managing a product for sale in one or a plurality of stores. The store is, for example, a supermarket and a convenience store, which are not limited thereto.

For example, the purchase history management system 100 displays, on the terminal 102, a purchase history of an associated product being a product associated with an intended purchase product. The intended purchase product is a product to be purchased by a customer in a store.

The associated product may be appropriately set, and is, for example, a product in which one or a plurality of a product category, a product name, and product identification (ID) for identifying the product are the same as those of the intended purchase product. The associated product may be a product in which one of a product category and a product name, and a size are the same as those of the intended purchase product.

As described above, the purchase history management system 100 includes the management apparatus 101 and the terminal 102. Note that, the terminal 102 included in the purchase history management system 100 may be one or plural.

### (Functional Configuration Example of Management Apparatus 101)

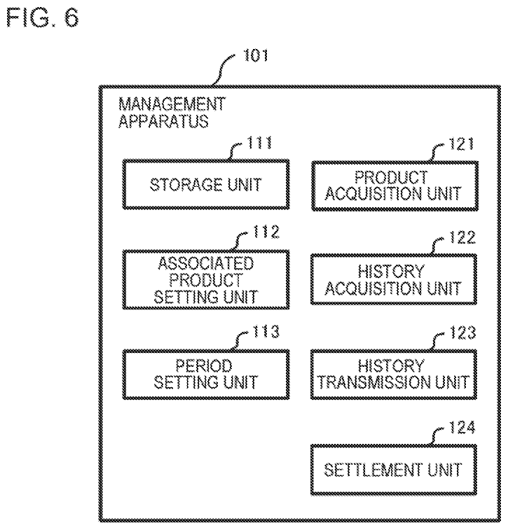

FIG. 6 is a diagram illustrating a functional configuration example of the management apparatus 101 according to the present example embodiment.

The management apparatus 101 is an apparatus for managing a product for sale in a store. The management apparatus 101 includes a storage unit 111 for storing various types of information, an associated product setting unit 112, a period setting unit 113, a product acquisition unit 121, a history acquisition unit 122, a history transmission unit 123, and a settlement unit 124.

The storage unit 111 stores, for example, product information 111a, setting information 111b, purchase history information 111c, and the like.

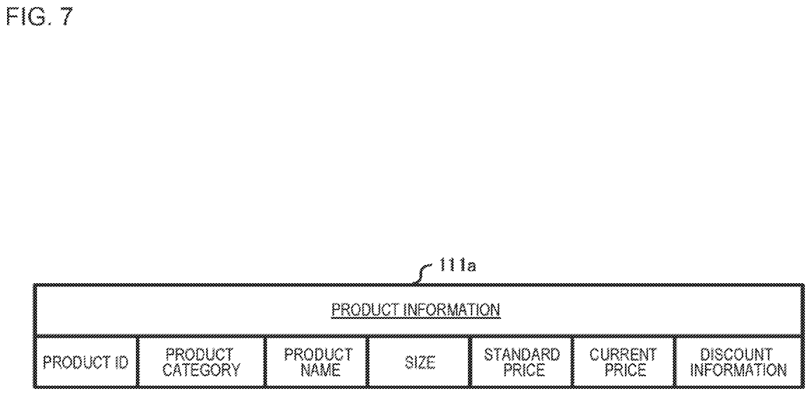

The product information 111a is information about a product for sale in a store. FIG. 7 is a diagram illustrating a configuration example of the product information 111a. For example, the product information 111a associates a product ID, a product category, a product name, a size, a standard price, a current price, and discount information with one another.

The product ID is information (product identification information) for identifying a product for sale in a store.

The product category indicates a category to which a product identified by using an associated product ID belongs. The product category may be appropriately set, and is, for example, milk, rice, curry roux, carrot, bread, jam, and the like.

The product name indicates a name of a product identified by using an associated product ID. The size indicates a size of a product identified by using an associated product ID.

The standard price indicates a standard sales price of a product identified by using an associated product ID.

The current price indicates a current sales price of a product identified by using an associated product ID.

The discount information indicates information about a discount of a product identified by using an associated product ID. The discount information may be set when a discount is given to a current price from a standard price. The discount information indicates, for example, a discount rate of a current price to a standard price, a discount amount of a current price to a standard price, and the like.

The setting information 111b is information being set in advance for defining a range of a purchase history of an associated product to be displayed on the terminal 102. The setting information 111b may be set by an employee, a customer, and the like of a store, or may be automatically set by the management apparatus 101 according to a predetermined rule.

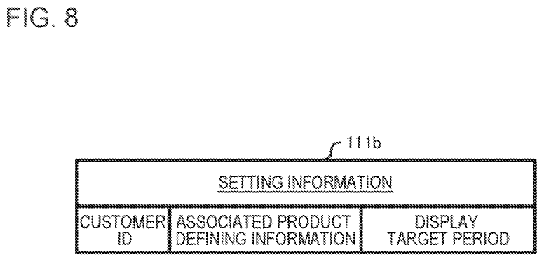

FIG. 8 is a diagram illustrating a configuration example of the setting information 111b. The setting information 111b associates, for example, a customer ID, associated product defining information, and a display target period with one another.

The customer ID is information (customer identification information) for identifying a customer. The setting information 111b includes a customer ID, and can thus associate associated product defining information and a display target period with each other for each customer. Note that, the setting information 111b may not include a customer ID, and, in this case, common associated product defining information and a common display target period may be applied to all customers.

The associated product defining information is information for defining a range of a product (associated product) associated with an intended purchase product. For example, the associated product defining information according to the present example embodiment defines a range of an associated product by using an attribute of a product. In other words, the associated product defining information according to the present example embodiment is an attribute of a product, and is, for example, a product category, a product name, or the like.

In the present example embodiment, a product having the same associated product defining information as that of an intended purchase product is a product (associated product) associated with the intended purchase product.

An associated product defined based on associated product defining information will be described by using a specific example. For example, when associated product defining information is a product category, it is assumed that there is a product whose product name is “∘∘ milk”, “ΔΔ milk”, “xx milk”, or the like among products belonging to a product category of “milk”.

In this case, for example, when a product category of an intended purchase product is “milk”, a product belonging to the same product category of “milk” as the product category of the intended purchase product is an associated product.

Further, for example, a case where associated product defining information is a product name will be described. When a product name of an intended purchase product is “∘∘ milk”, a product having the same name of “∘∘ milk” as the product name of the intended purchase product is an associated product.

Note that, an attribute of a product indicated by associated product defining information is not limited to a product category or a product name, and may be, for example, a product ID, or a combination of any one of a product category and a product name, and a size. Further, as long as associated product defining information can define a range of an associated product, the associated product defining information is not limited to an attribute of a product.

The display target period is information that defines a range in terms of time of a purchase history to be displayed on the terminal 102. For example, seven days, three days, and the like are set as the display target period. For example, when the display target period is seven days, a purchase history to be displayed on the terminal 102 is a purchase history within seven days from when a customer does shopping in a store.

The display target period is associated with associated product defining information, and can thus be set for each piece of the associated product defining information. Note that, the display target period may not be associated with associated product defining information, and, in this case, a common display target period may be applied to all products.

The purchase history information 111c is information indicating a purchase history of a customer for a product for sale in a store. In other words, the purchase history information 111c indicates a purchase history of a product by customer.

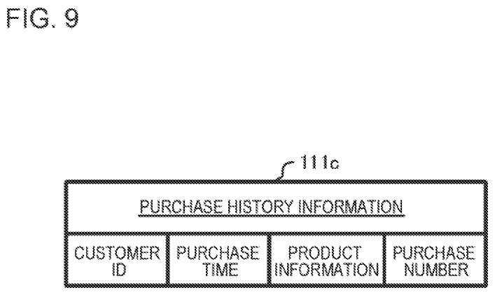

FIG. 9 is a diagram illustrating a configuration example of the purchase history information 111c. The purchase history information 111c associates, for example, a customer ID, purchase time, product information, and a purchase number with one another.

The purchase time is information indicating time at which a customer identified by using an associated customer ID purchases a product in a store. The purchase time includes, for example, a date. The purchase time may further include a time.

The product information included in the purchase history information 111c is product information about a product purchased at associated purchase time by a customer identified by using an associated customer ID. For example, the product information may include items (i.e., a product ID, a product category, a product name, a size, a standard price, a current price, and discount information) similar to those of the product information 111a described above. However, a standard price included in the purchase history information 111c is a standard price when a customer has made a purchase in the past. Further, a current price included in the purchase history information 111c is a current price when a customer has made a purchase in the past, i.e., a price (purchase price) applied when the customer has made a purchase in the past.

Note that, the product information included in the purchase history information 111c may include an item different from that of the product information 111a, and may be, for example, a part of an item constituting the product information 111a.

The purchase number is information indicating a number of purchased products being identified by using associated product information at associated purchase time by a customer identified by using an associated customer ID.

FIG. 6 is referred again.

The associated product setting unit 112 sets associated product defining information in the setting information 111b. The associated product setting unit 112 may set, for example, as initial setting for registering a customer in the management apparatus 101, associated product defining information in the setting information 111b according to a predetermined rule.

Further, for example, the associated product setting unit 112 may set associated product defining information specified by a customer via the terminal 102 in the setting information 111b about the customer. In this case, the customer may specify any piece of associated product defining information, or may select associated product defining information from among a plurality of pieces of associated product defining information being prepared. In this way, associated product defining information according to a preference of a customer can be set.

The period setting unit 113 acquires a display target period, based on a frequency with which a customer purchases a product belonging to a range defined by associated product defining information. For example, the associated product setting unit 112 refers to the purchase history information 111c, and acquires, for each customer, a purchase frequency (for example, an average purchase cycle) of a product belonging to a range defined by associated product defining information. Then, the period setting unit 113 associates the acquired display target period with the associated product defining information being associated, and sets the setting information 111b about an associated customer. In this way, the display target period can be automatically set.

The period setting unit 113 may set, for example, as initial setting, a display target period in the setting information 111b according to a predetermined rule. Further, for example, the period setting unit 113 may set a display target period specified by a customer via the terminal 102 in the setting information 111b about the customer. In these examples, the period setting unit 113 may set a display target period common to associated product defining information, but may set a display target period different for each piece of associated product defining information according to a predetermined rule or specification by a customer.

The product acquisition unit 121 acquires, from the terminal 102 being operated by a customer, a customer ID for identifying the customer and a product ID for an intended purchase product of the customer.

The product acquisition unit 121 acquires a customer ID, based on a login operation on the terminal 102 of a customer, and the like, for example. The product acquisition unit 121 acquires a product ID included in a bar code read by the terminal 102, a radio frequency identification (RFID) tag, and the like, for example.

The product acquisition unit 121 acquires intended purchase product information, based on the acquired product ID. The intended purchase product information is the product information 111a about an intended purchase product. Specifically, for example, the product acquisition unit 121 acquires, as the intended purchase product information, the product information 111a associated with the acquired product ID, and transmits the intended purchase product information to the terminal 102.

The history acquisition unit 122 acquires a purchase history of an associated product being a product associated with the intended purchase product among purchase histories of a customer being a target, based on the purchase history information 111c. The history acquisition unit 122 may further acquire a purchase history of a simultaneous purchase product, based on the purchase history information 111c. The simultaneous purchase product is a product being purchased simultaneously with the associated product among purchase histories of a customer being a target.

The history transmission unit 123 transmits, to the terminal 102, the purchase history of the associated product being acquired by the history acquisition unit 122 in order to display the purchase history on the terminal 102 of a customer. The history transmission unit 123 may transmit, to the terminal 102, the purchase history of the simultaneous purchase product being acquired by the history acquisition unit 122.

Note that, the purchase history may include at least one of purchase time, a product name, a purchase price, a purchase number, and discount information.

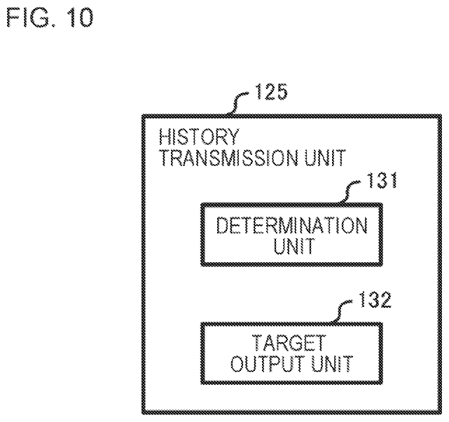

FIG. 10 is a diagram illustrating a functional configuration example of the history transmission unit 123 according to the present example embodiment. The history transmission unit 123 includes a determination unit 131 and a target output unit 132.

The determination unit 131 determines whether a purchase history of an associated product being acquired by the history acquisition unit 122 satisfies a predetermined display condition.

The display condition is a condition predetermined for determining a purchase history of an associated product being a display target on the terminal 102. For example, the display condition is a condition that an associated product is purchased within a predetermined display target period. In this case, for example, the determination unit 131 acquires the setting information 111b, and determines a purchase history of an associated product being a display target, based on a display target period associated with associated product defining information that defines a range to which an intended purchase product belongs.

Note that, the display condition may be a condition that a price difference between a purchase price of an associated product and a current price of an intended purchase product is equal to or more than a reference value, a condition that a purchase history of an associated product is a latest purchase history of the associated product, or the like. The display condition may include at least one condition, and may include at least one of the display conditions exemplified herein, for example.

The target output unit 132 transmits, to the terminal 102, the purchase history of the associated product determined by the determination unit 131 to satisfy the display condition. The target output unit 132 may transmit, to the terminal 102, a purchase history of a product being purchased simultaneously with the associated product determined by the determination unit 131 to satisfy the display condition, among simultaneous purchase products being acquired by the history acquisition unit 122.

FIG. 6 is referred again.

The settlement unit 124 performs settlement processing, based on product identification information about an intended purchase product, when a customer instructs settlement via the terminal 102. Specifically, for example, the settlement unit 124 refers to the product information 111a, and performs settlement processing of an intended purchase product by using a current price associated with product identification information about the intended purchase product.

Note that, the settlement processing is not limited to being performed in the management apparatus 101, and may be performed in another apparatus (for example, a settlement apparatus installed in a store, another server connected to the network N).

### (Functional Configuration Example of Terminal 102)

The terminal 102 is a terminal for a customer to register an intended purchase product in a store. As described above, the terminal is a portable terminal being operated by a customer in a store, and is, for example, a smartphone, a tablet terminal, and the like. The terminal 102 may be lent to a customer in a store, may be installed in a cart, or may be a terminal possessed by a customer. A predetermined application or predetermined software may be installed in the terminal.

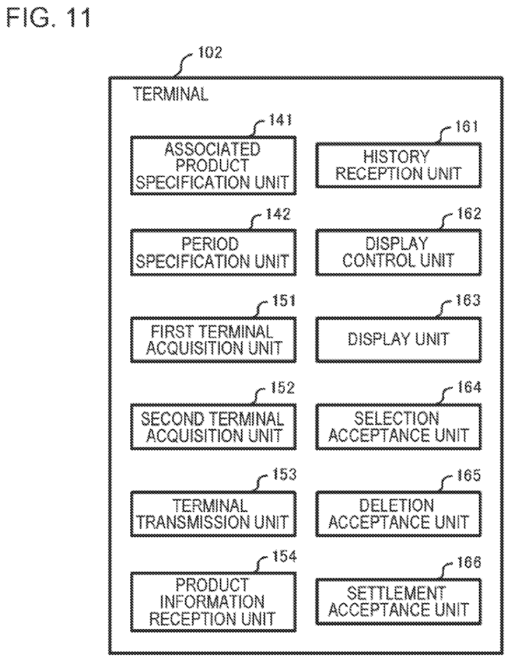

FIG. 11 is a diagram illustrating a functional configuration example of the terminal 102 according to the present example embodiment. The terminal 102 includes an associated product specification unit 141, a period specification unit 142, the first terminal acquisition unit 151, the second terminal acquisition unit 152, the terminal transmission unit 153, a product information reception unit 154, the history reception unit 161, the display control unit 162, a display unit 163, a selection acceptance unit 164, a deletion acceptance unit 165, and a settlement acceptance unit 166.

For example, when the associated product specification unit 141 accepts specification by a customer related to associated product defining information according to an input of the customer, the associated product specification unit 141 transmits, to the management apparatus 101, the accepted associated product defining information together with a customer ID of the customer. In this way, the associated product setting unit 112 can set, in the setting information 111b, the associated product defining information being specified by the customer.

For example, when the period specification unit 142 accepts specification by a customer related to a display target period associated with associated product defining information according to an input of the customer, the period specification unit 142 transmits, to the management apparatus 101, the accepted display target period together with the associated product defining information being associated and a customer ID of the customer. In this way, the period setting unit 113 can set, in the setting information 111b, the display target period being specified by the customer.

The first terminal acquisition unit 151 acquires a customer ID of a customer, based on a login operation of the customer, and the like, for example. The first terminal acquisition unit 151 transmits the acquired customer ID to the management apparatus 101.

The second terminal acquisition unit 152 is formed of a camera, an RFID tag reader, or the like, for example. When the second terminal acquisition unit 152 detects a bar code, an RFID tag, or the like provided to an intended purchase product, the second terminal acquisition unit 152 reads information included in this and acquires a product ID of the intended purchase product.

The terminal transmission unit 153 transmits, to the management apparatus 101, the customer ID being acquired by the first terminal acquisition unit 151 and the product ID being acquired by the second terminal acquisition unit 152.

The product information reception unit 154 acquires the product information 111a (intended purchase product information) about an intended purchase product from the management apparatus 101. The product information reception unit 154 may hold the acquired intended purchase product information.

The history reception unit 161 receives, from the management apparatus 101, a purchase history of an associated product being a product associated with the intended purchase product among purchase histories of a customer. The history reception unit 161 may receive, from the management apparatus 101, a purchase history of a simultaneous purchase product being a product purchased together with the associated product among purchase histories of a customer.

The display control unit 162 displays various types of information on the display unit 163 formed of a display and the like.

For example, the display control unit 162 displays, on the display unit 163, the purchase history of the associated product being received by the history reception unit 161.

Further, for example, the display control unit 162 may display intended purchase product information on the display unit 163. In this case, the display control unit 162 may display, on the display unit 163, intended purchase product information being held by the product information reception unit 154. The display control unit 162 may simultaneously display, on the display unit 163, a purchase history of an associated product and intended purchase product information.

The selection acceptance unit 164 accepts selection for referring to a purchase history of a simultaneous purchase product, based on an input of a customer being performed when the customer desires to refer to details of a purchase history of an associated product displayed on the display unit 163, and the like, for example.

Specifically, for example, the selection acceptance unit 164 accepts selection of any of purchase histories of an associated product being displayed on the display unit 163. The selection acceptance unit 164 requests, from the management apparatus 101, a purchase history of a simultaneous purchase product being a product purchased together with the selected associated product.

When the selection acceptance unit 164 accepts the selection, the history reception unit 161 may receive the purchase history of the simultaneous purchase product from the management apparatus 101. Further, the display control unit 162 may display, on the display unit 163, the purchase history of the simultaneous purchase product being received by the history reception unit 161.

The deletion acceptance unit 165 accepts selection for deleting an intended purchase product, based on an input of a customer being performed when the customer cancels a purchase of the intended purchase product, and the like, for example.

Specifically, for example, the deletion acceptance unit 165 accepts selection of any of intended purchase products being displayed on the display unit 163. When the deletion acceptance unit 165 accepts selection of an intended purchase product, the deletion acceptance unit 165 performs processing for deleting the selected intended purchase product.

The settlement acceptance unit 166 accepts a settlement instruction of a customer, based on an input of the customer, for example. The settlement instruction is an instruction for performing settlement of an intended purchase product.

Specifically, for example, the settlement acceptance unit 166 transmits, to the management apparatus 101, a settlement request including a product ID included in the intended purchase product information being held by the product information reception unit 154. In this way, the management apparatus 101 performs the settlement processing of the intended purchase product.

The functional configuration example of the purchase history management system 100 according to the present example embodiment is mainly described above. Hereinafter, a physical configuration example of the purchase history management system 100 will be described.

### (Physical Configuration Example of Management Apparatus 101)

The management apparatus 101 is, for example, a general-purpose computer, and the like.

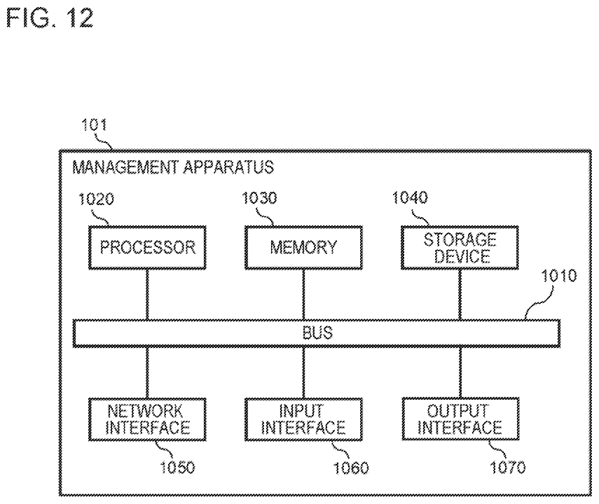

FIG. 12 is a diagram illustrating a physical configuration example of the management apparatus 101. The management apparatus 101 includes, for example, a bus 1010, a processor 1020, a memory 1030, a storage device 1040, a network interface 1050, an input interface 1060, and an output interface 1070.

The bus 1010 is a data transmission path for allowing the processor 1020, the memory 1030, the storage device 1040, the network interface 1050, the input interface 1060, and the output interface 1070 to transmit and receive data with one another. However, a method for connecting the processor 1020 and the like to one another is not limited to bus connection.

The processor 1020 is a processor achieved by a central processing unit (CPU), a graphics processing unit (GPU), and the like.

The memory 1030 is a main storage apparatus achieved by a random access memory (RAM) and the like.

The storage device 1040 is an auxiliary storage apparatus achieved by a hard disk drive (HDD), a solid state drive (SSD), a memory card, a read only memory (ROM), or the like. The storage device 1040 stores a program module for achieving each function of the management apparatus 101. The processor 1020 reads each program module onto the memory 1030 and executes the program module, and each function associated with the program module is achieved.

The network interface 1050 is an interface for being connected to the network N. The input interface 1060 is an interface for a user to input information, and is formed of, for example, a touch panel, a keyboard, a mouse, and the like. The output interface 1070 is an interface for providing information to a user, and is formed of, for example, a liquid crystal panel, an organic electro-luminescence (EL) panel, and the like. The input interface 1060 and the output interface 1070 may constitute a touch panel.

### (Physical Configuration Example of Terminal 102)

The terminal 102 is, for example, a smartphone, a tablet terminal, and the like.

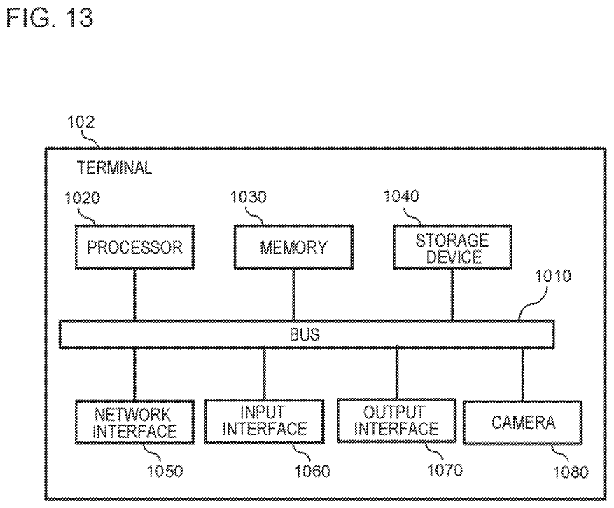

FIG. 13 is a diagram illustrating a physical configuration example of the terminal 102. The terminal 102 includes, for example, a bus 1010, a processor 1020, a memory 1030, a storage device 1040, a network interface 1050, an input interface 1060, and an output interface 1070 that are similar to those of the management apparatus 101. The terminal 102 further includes a camera 1080 connected to the bus 1010. The camera 1080 captures a subject such as a bar code. Note that, the terminal 102 may include an RFID tag reader in addition to the camera 1080 or instead of the camera 1080.

The physical configuration example of the purchase history management system 100 according to the present example embodiment is described above. Hereinafter, an operation example of the purchase history management system 100 will be described.

### (Operation of Purchase History Management System 100)

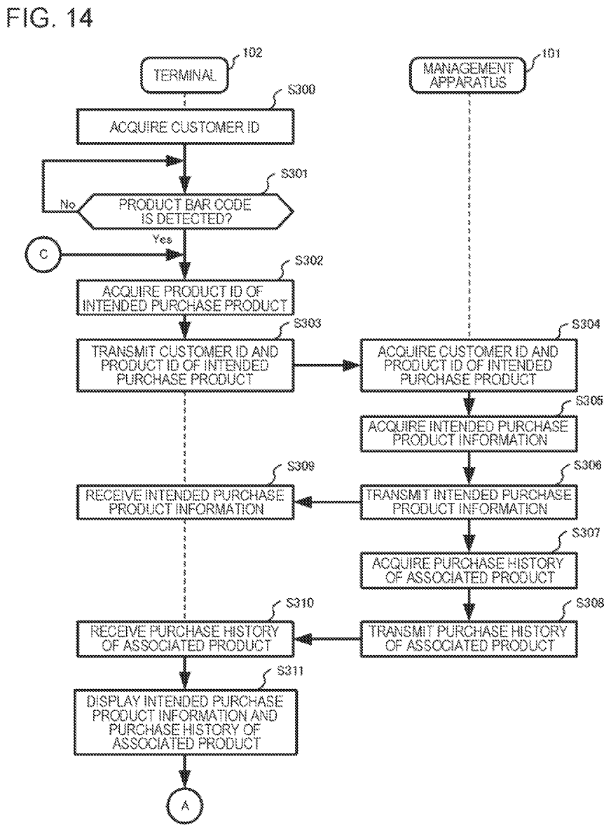

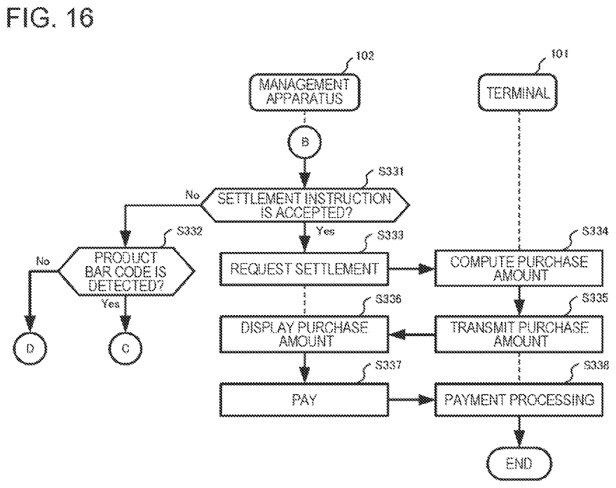

FIGS. 14 to 16 are flowcharts illustrating one example of purchase history management processing according to the present example embodiment. The purchase history management processing is processing performed by the purchase history management system 100. The purchase history management processing includes management processing performed by the management apparatus 101 and terminal processing performed by the terminal 102.

The purchase history management system 100 starts by activating a predetermined application or predetermined software installed in the terminal 102 before a customer visits a store, and the like, for example. The setting information 111b is preset as a premise of an operation of the purchase history management system 100 illustrated in FIGS. 14 to 16.

The first terminal acquisition unit 151 acquires a customer ID of a customer, based on an input of the customer, for example (step S300). The customer ID acquired herein may be used for log-in processing (not illustrated) to the management apparatus 101.

The second terminal acquisition unit 152 determines whether a product ID included in a product bar code is detected (step S301). For example, the second terminal acquisition unit 152 detects a product ID of an intended purchase product by capturing a product bar code provided to the intended purchase product of a customer by a camera. Note that, when a product ID is held in an RFID tag provided to an intended purchase product, the second terminal acquisition unit 152 detects the product ID of the intended purchase product by, for example, a customer holding an RFID tag reader over the RFID tag.

When it is determined that the product ID is not detected (step S301; No), the second terminal acquisition unit 152 repeatedly performs step S102, and waits until the product ID is detected.

When it is determined that the product ID is detected (step S301; Yes), the second terminal acquisition unit 152 acquires the detected product ID, i.e., the product ID of the intended purchase product (step S302).

The terminal transmission unit 153 transmits the customer ID and the product ID of the intended purchase product to the management apparatus 101 (step S303). The customer ID transmitted in step S303 is the customer ID acquired in step S300. Further, the product ID transmitted in step S303 is the product ID acquired in step S302.

The product acquisition unit 121 acquires the customer ID and the product ID of the intended purchase product that are transmitted in step S303 (step S304).

The product acquisition unit 121 acquires intended purchase product information, based on the product information 111a and the product ID of the intended purchase product acquired in step S304 (step S305). The product acquisition unit 121 transmits the intended purchase product information acquired in step S305 to the terminal 102 (step S306).

The history acquisition unit 122 acquires a purchase history of an associated product among purchase histories of the customer identified by using the customer ID acquired in step S304, based on the purchase history information 111c, the setting information 111b, and the product ID of the intended purchase product acquired in step S304 (step S307).

Specifically, for example, the history acquisition unit 122 extracts a purchase history associated with the customer ID acquired in step S304, based on the purchase history information 111c. The history acquisition unit 122 determines associated product defining information associated with the customer ID acquired in step S304, based on the setting information 111b. The history acquisition unit 122 acquires a purchase history of a product belonging to a range defined by the determined associated product defining information among purchase histories associated with the customer ID. As a result of such processing, the history acquisition unit 122 can acquire the purchase history of the associated product among the purchase histories of the customer.

The history transmission unit 125 transmits the purchase history of the associated product acquired in step S307 to the terminal 102 (step S308). In the present example embodiment, a purchase history of an associated product that satisfies a display condition among the purchase histories of the associated product acquired in step S307 is transmitted to the terminal 102.

Specifically, for example, the determination unit 131 determines whether each of the purchase histories of the associated product acquired in step S307 satisfies the display condition.

For example, when the display condition includes a purchase of the associated product within a predetermined display target period, the determination unit 131 refers to the setting information 111b. Then, the determination unit 131 determines a display target period for each piece of the associated product defining information associated with the customer ID acquired in step S304, based on the setting information 111b.

The determination unit 131 determines, for each of the purchase histories of the associated product acquired in step S307, whether purchase time is within the display target period for the associated product defining information that defines a range to which the associated product belongs. When the purchase time is within the display target period, the determination unit 131 determines that the purchase history of the associated product satisfies the display condition. When the purchase time is not within the display target period, the determination unit 131 determines that the purchase history of the associated product does not satisfy the display condition.

The target output unit 132 transmits the purchase history of the associated product acquired in step S307 to the terminal 102, based on the determination result of the determination unit 131. More specifically, the target output unit 132 transmits, to the terminal 102, the purchase history of the associated product determined by the determination unit 131 to satisfy the display condition among the purchase histories of the associated product acquired in step S307.

The product information reception unit 154 receives, from the management apparatus 101, the intended purchase product information transmitted in step S308 (step S309). The product information reception unit 154 may hold the intended purchase product information received in step S309.

The history reception unit 161 receives, from the management apparatus 101, the purchase history of the associated product transmitted in step S308 (step S310). The history reception unit 161 may hold the purchase history of the associated product received in step S310.

The display control unit 162 displays, on the display unit 163, the intended purchase product information and the purchase history of the associated product that are received in steps S309 and S310, respectively (step S311).

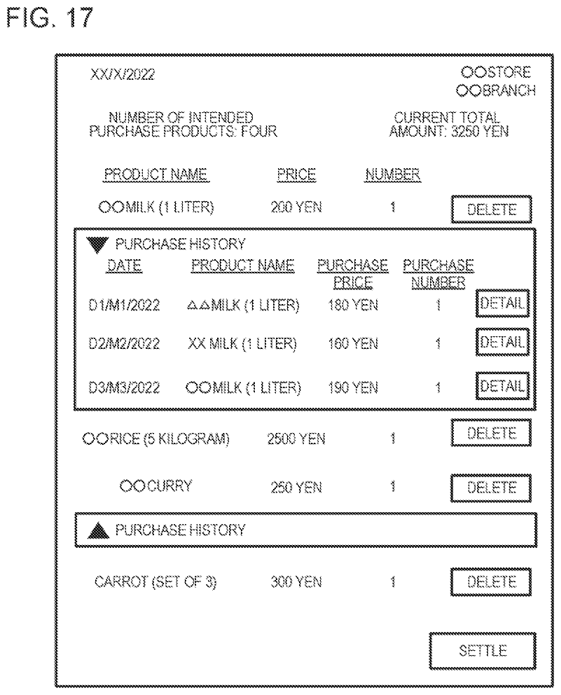

FIG. 17 is a diagram illustrating one example of a first screen being a screen for displaying intended purchase product information and a purchase history of an associated product.

The first screen illustrated in FIG. 17 illustrates an example including, as intended purchase products, “∘∘ milk (1 liter)”, “∘∘ rice (5 kilogram)”, “∘∘ curry”, and “carrot (set of 3)”. Further, the first screen illustrated in FIG. 17 includes a price, a number, and a deletion button that are associated with each of the intended purchase products.

The price herein indicates a current price of an associated intended purchase product. The number indicates a number of intended purchases of an associated intended purchase product. The deletion button is a button for deleting an associated intended purchase product from the intended purchase product information being held by the product information reception unit 154 and the first screen.

The first screen illustrated in FIG. 17 displays a purchase history of an associated product being associated with each of “∘∘ milk (1 liter)” and “∘∘ curry” among the intended purchase products. This indicates that the purchase history of the associated product being associated with each of “∘∘ milk (1 liter)” and “∘∘ curry” is received in step S310.

The purchase history of the associated product being associated with “∘∘ milk (1 liter)” is displayed in a developed manner. The purchase history of the associated product being associated with “∘∘ curry” is not displayed, and is to be displayed in a developed manner similarly to the purchase history of “∘∘ milk (1 liter)” by pressing an upward triangular mark displayed beside “purchase history”, for example.

The purchase history of the associated product being associated with “∘∘ milk (1 liter)” illustrated in FIG. 17 is an example including a purchase history of a product belonging to the same product category as that of the intended purchase product of “milk”. Further, the purchase history of the associated product illustrated in FIG. 17 includes a date on which the associated product is purchased, a product name of the associated product, a purchase price, and a purchase number. Furthermore, a detail button for referring to a purchase history of a simultaneous purchase product is associated with each of the purchase histories of the associated product.

The first screen illustrated in FIG. 17 includes, in a right lower portion, a settlement button for performing a settlement instruction by a customer.

Note that, the configuration of the first screen is not limited to the example illustrated in FIG. 17, and may be changed in various ways. For example, purchase histories of an intended purchase product and an associated product may be displayed on different screens. Further, for example, the first screen may include an average price of purchase prices of associated products, an average price of associated products in a predetermined period, and the like. Furthermore, for example, a purchase history of an associated product included in the first screen may only be a purchase history of an associated product being purchased last time in a store, or may only be a purchase number of an associated product in a display target period. Furthermore, for example, a purchase history of an associated product included in the first screen may include presence or absence of a discount when the associated product is purchased last time in a store, or may include a price difference between a previous purchase price and a current price. Furthermore, for example, a list of intended purchase products as illustrated in FIG. 17 may be created by the terminal 102, or may be created by the management apparatus 101.

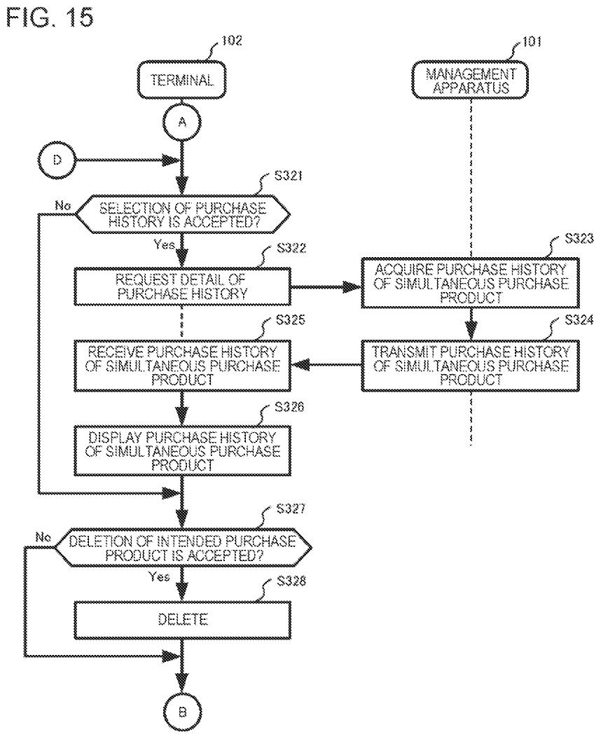

FIG. 15 is referred.

The selection acceptance unit 164 determines whether selection of the purchase history displayed in step S311 is accepted (step S321).

Specifically, for example, when any of the detail buttons included in the first screen is pressed, the selection acceptance unit 164 determines that selection of a purchase history associated with the pressed detail button is accepted.

When it is determined that selection of the purchase history is accepted (step S321; Yes), the selection acceptance unit 164 requests details of the purchase history from the management apparatus 101 (step S322). The request includes, for example, the purchase history (for example, a date, a product ID) of the selected associated product and a customer ID.

When the history acquisition unit 122 receives the request transmitted in step S322, the history acquisition unit 122 acquires a purchase history of a simultaneous purchase product (step S323).

Specifically, for example, the history acquisition unit 122 acquires a purchase history of a simultaneous purchase product, based on the purchase history of the associated product and the customer ID that are included in the request transmitted in step S322, and the purchase history information 111c.

The history transmission unit 123 transmits the purchase history of the simultaneous purchase product acquired in step S323 to the terminal 102 (step S324).

The history reception unit 161 receives the purchase history of the simultaneous purchase product transmitted in step S324 (step S325).

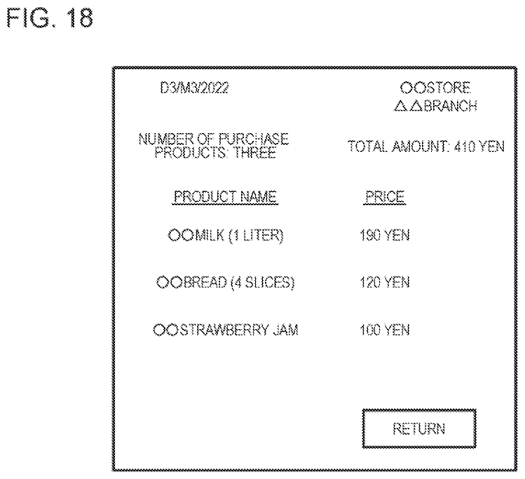

The display control unit 162 displays the purchase history of the simultaneous purchase product acquired in step S325 on the display unit 163 (step S326). FIG. 18 is a diagram illustrating one example of a second screen being a screen for displaying a purchase history of a simultaneous purchase product. For example, the display control unit 162 continuously displays a purchase history of a simultaneous purchase product on the display unit 163 until a return button included in the second screen illustrated in FIG. 18 is pressed.

After step S325 or when it is determined that selection of a purchase history is not accepted (step S321; No), the deletion acceptance unit 165 determines whether deletion of an intended purchase product included in the purchase history displayed in step S311 is accepted (step S327).

Specifically, for example, when any of the deletion buttons included in the first screen is pressed, the deletion acceptance unit 165 determines that selection for deleting an intended purchase product associated with the pressed deletion button is accepted.

When it is determined that deletion is accepted (step S327; Yes), the deletion acceptance unit 165 deletes the selected intended purchase product (step S328).

Specifically, for example, the deletion acceptance unit 165 deletes intended purchase product information about the selected intended purchase product from the intended purchase product information being held by the product information reception unit 154. Then, the deletion acceptance unit 165 notifies the display control unit 162 that the selected intended purchase product is to be deleted. In response to reception of the notification, the display control unit 162 displays again, on the display unit 163, the intended purchase product information being held by the product information reception unit 154. In this way, the purchase history of the selected intended purchase product is deleted from the first screen.

After step S328 or when it is determined that deletion of an intended purchase product is not accepted (step S327; No), the settlement acceptance unit 166 determines whether a settlement instruction is accepted (step S331).

Specifically, for example, when the settlement button included in the first screen is pressed, the settlement acceptance unit 166 determines that a settlement instruction is accepted.

When it is determined that the settlement instruction is not accepted (step S331; No), the second terminal acquisition unit 152 determines whether a product ID included in a product bar code is detected, similarly to step S301 (step S332).

When it is determined that the product ID is detected (step S332; Yes), the second terminal acquisition unit 152 performs step S302 again. In this way, an intended purchase product can be added.

When it is determined that the product ID is not detected (step S332; No), the selection acceptance unit 164 determines whether selection of the purchase history displayed in step S311 is accepted (step S321). In this way, the processing in steps S321 to S331 is repeatedly performed until an intended purchase product is added.

When it is determined that the settlement instruction is accepted (step S331; Yes), the settlement acceptance unit 166 transmits, to the management apparatus 101, a settlement request including a product ID and a number included in the intended purchase product information being held by the product information reception unit 154 (step S333).

When the settlement unit 124 receives the settlement request transmitted in step S333, the settlement unit 124 computes a purchase amount, based on the product ID and the number included in the settlement request, and the product information 111a (step S334). For example, the settlement unit 124 computes a purchase amount by acquiring, for each product ID, a subtotal acquired by multiplying a current price of a product identified by using a product ID by a number of the product, and adding the acquired subtotal.

The settlement unit 124 transmits settlement information to the terminal 102 (step S335). The settlement information includes the product information 111a (for example, a product name, a current price) and a number of an intended purchase product being a target for computing a purchase amount, and the purchase amount acquired in step S334.

When the settlement acceptance unit 166 receives the settlement information transmitted in step S335, the display control unit 162 displays the received settlement information on the display unit 163 (step S336). In this way, a customer can confirm the settlement information displayed in step S336.

When the settlement acceptance unit 166 accepts an instruction for performing a payment, the settlement acceptance unit 166 requests a payment based on the settlement information from the management apparatus 101 (step S338). The request may include a payment method such as a payment by a previously registered credit card and a deduction from a bank account.

When the settlement unit 124 accepts the request transmitted in step S337, the settlement unit 124 performs payment processing according to the request (step S338), and ends the purchase history management processing. Settlement of an intended purchase product is performed by performing the processing in steps S333 to S338.

### (Action and Effect)

As described above, according to the present example embodiment, the management apparatus 101 includes the product acquisition unit 121, the history acquisition unit 122, and the history transmission unit 123. The product acquisition unit 121 acquires, from the terminal 102 of a portable type being operated by a customer in a store, customer identification information for identifying the customer and product identification information about an intended purchase product of the customer. The history acquisition unit 122 acquires a purchase history of an associated product being a product associated with the intended purchase product among purchase histories of the customer, based on purchase history information indicating a purchase history of a product by customer. The history transmission unit 123 transmits the purchase history of the associated product to the terminal 102.

In this way, a customer can refer to a purchase history of an associated product being associated with an intended purchase product in order to determine whether to actually purchase the intended purchase product. Therefore, the customer can use a purchase history of the customer in order to purchase a product in a store.

According to the present example embodiment, the history transmission unit 123 includes the determination unit 131 and the target output unit 132. The determination unit 131 determines whether a purchase history of an associated product satisfies a predetermined display condition. The target output unit 132 transmits, to the terminal 102, the purchase history of the associated product determined to satisfy the display condition.

In this way, a purchase history of an associated product being referred for determining whether an intended purchase product is to be actually purchased can be narrowed down by using a display condition. Thus, a customer can more easily refer to a purchase history of an associated product than when many purchase histories of an associated product are displayed. Therefore, the customer can use a purchase history of the customer in order to purchase a product in a store.

According to the present example embodiment, the display condition includes at least one of a condition that a price difference between a purchase price of an associated product and a current price of an intended purchase product is equal to or more than a reference value, a condition that an associated product is purchased within a predetermined display target period, and a condition that a purchase history of an associated product is a latest purchase history of the associated product.

In this way, a purchase history of an associated product being referred for determining whether an intended purchase product is to be actually purchased can be narrowed down by using a display condition. Thus, a customer can more easily refer to a purchase history of an associated product than when many purchase histories of an associated product are displayed. Therefore, the customer can use a purchase history of the customer in order to purchase a product in a store.

According to the present example embodiment, the determination unit 131 acquires setting information that associates, with a display target period, associated product defining information for defining a range of a product associated with an intended purchase product.

In this way, a purchase history of an associated product being referred for determining whether an intended purchase product is to be actually purchased can be narrowed down by using a display target period for each piece of associated product defining information. Since an interval of a purchase is generally different depending on a product belonging to a range defined by associated product defining information, a purchase history of an associated product can be appropriately narrowed down by using a display target period for each piece of the associated product defining information. Therefore, a customer can use a purchase history of the customer in order to purchase a product in a store.

According to the present example embodiment, the management apparatus 101 further includes the period setting unit 113. The period setting unit 113 acquires a display target period, based on a frequency with which a customer purchases a product belonging to a range defined by associated product defining information, associates the acquired display target period with the associated product defining information, and sets the setting information 111b about the customer.

In this way, a display target period associated with associated product defining information can be set for each customer. An interval of a purchase of a product belonging to a range defined by associated product defining information may be generally different for each customer. A purchase history of an associated product can be appropriately narrowed down by using a display target period desired for each customer. Therefore, a customer can use a purchase history of the customer in order to purchase a product in a store.

According to the present example embodiment, the history transmission unit 123 transmits, to the terminal 102, a purchase history of a simultaneous purchase product being a product purchased together with an associated product.

In this way, a customer can refer to a purchase history of a simultaneous purchase product when the customer actually purchases an intended purchase product. Thus, a product that needs to be purchased together with the intended purchase product can be less forgotten to be bought. Therefore, the customer can use a purchase history of the customer in order to purchase a product in a store.

According to the present example embodiment, a purchase history includes at least one of purchase time, a purchase price, a purchase number, and discount information of an associated product.

In this way, a customer can refer to at least one of purchase time, a purchase price, a purchase number and discount information of an associated product being associated with an intended purchase product in order to determine whether to actually purchase the intended purchase product. Therefore, the customer can use a purchase history of the customer in order to purchase a product in a store.

According to the present example embodiment, the management apparatus 101 further includes the settlement unit 124. The settlement unit 124 performs settlement processing, based on product identification information about an intended purchase product.

In this way, a customer can easily perform settlement by using information being input for acquiring a purchase history of an associated product. Therefore, time and effort for a purchase of a product of a customer can be reduced.

According to the present example embodiment, the terminal 102 is a portable terminal being operated by a customer in a store. The terminal 102 includes the first terminal acquisition unit 151, the second terminal acquisition unit 152, the terminal transmission unit 153, the history reception unit 161, and the display control unit 162.

The first terminal acquisition unit 151 acquires customer identification information for identifying a customer. The second terminal acquisition unit 152 acquires product identification information about an intended purchase product of the customer. The terminal transmission unit 153 transmits the customer identification information and the product identification information to the management apparatus 101. The history reception unit 161 receives, from the management apparatus 101, a purchase history of an associated product being a product associated with the intended purchase product among purchase histories of the customer. The display control unit 162 displays the purchase history of the associated product on the display unit 163.

In this way, a customer can refer to a purchase history of an associated product being associated with an intended purchase product in order to determine whether to actually purchase the intended purchase product. Therefore, the customer can use a purchase history of the customer in order to purchase a product in a store.

According to the present example embodiment, the display control unit 162 further displays, on the display unit 163, product information about an intended purchase product.

In this way, a customer can refer to a purchase history of an associated product being associated with an intended purchase product, and product information about the intended purchase product in order to determine whether to actually purchase the intended purchase product. Therefore, the customer can use a purchase history of the customer in order to purchase a product in a store.

According to the present example embodiment, the display control unit 162 simultaneously displays, on the display unit 163, a purchase history of an associated product and product information about an intended purchase product.

In this way, a customer can simultaneously refer to a purchase history of an associated product being associated with an intended purchase product, and product information about the intended purchase product in order to determine whether to actually purchase the intended purchase product. Therefore, the customer can use a purchase history of the customer in order to purchase a product in a store.

According to the present example embodiment, the terminal 102 further includes the selection acceptance unit 164. The selection acceptance unit 164 accepts selection of an associated product included in a purchase history. The history reception unit 161 further receives, from the management apparatus 101, a purchase history of a simultaneous purchase product being a product purchased together with the associated product. The display control unit 162 displays the received purchase history of the simultaneous purchase product on the display unit 163.

In this way, a customer can refer to a purchase history of a simultaneous purchase product when the customer actually purchases an intended purchase product. Thus, a product that needs to be purchased together with the intended purchase product can be less forgotten to be bought. Therefore, the customer can use a purchase history of the customer in order to purchase a product in a store.

### Modification Example 1

In the example embodiment, an example in which the management apparatus 101 determines whether a purchase history of an associated product satisfies a display condition, and transmits the purchase history of the associated product that satisfies the display condition to the terminal 102 is described.

However, the management apparatus 101 may transmit a purchase history of an associated product to the terminal 102 regardless of whether a display condition is satisfied. Then, the terminal 102 may determine whether the purchase history of the associated product satisfies the display condition, and may display the purchase history of the associated product that satisfies the display condition. In a modification example 1, such a modification example will be described.

In the present modification example, the history transmission unit 125 may not include the determination unit 131 and the target output unit 132. In other words, for example, the history transmission unit 125 transmits, to the terminal 102, all purchase histories of an associated product being acquired by the history acquisition unit 122. As a result, the product information reception unit 154 receives all the purchase histories of the associated product from the management apparatus 101.

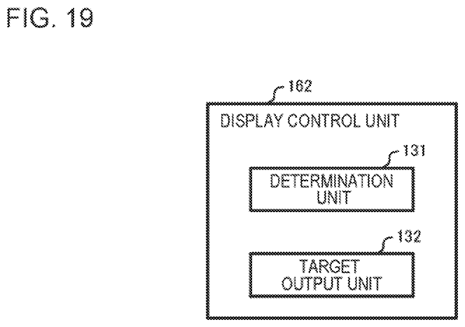

In the present modification example, the display control unit 162 includes the determination unit 131 and the target output unit 132. FIG. 19 is a diagram illustrating a functional configuration example of the display control unit 162 according to the present modification example.

The determination unit 131 according to the present modification example determines whether a purchase history of an associated product being received by the product information reception unit 154 satisfies a predetermined display condition. The target output unit 132 according to the present modification example displays, on the display unit 163, the purchase history of the associated product determined by the determination unit 131 to satisfy the display condition.

According to the present modification example, the display control unit 162 includes the determination unit 131 and the target output unit 132. Similarly to the example embodiment, the determination unit 131 determines whether a purchase history of an associated product satisfies a predetermined display condition. The target output unit 132 displays, on the display unit 163, the purchase history of the associated product determined to satisfy the display condition.

In this way, similarly to the example embodiment, a purchase history of an associated product being referred for determining whether an intended purchase product is to be actually purchased can be narrowed down by using a display condition. Thus, a customer can more easily refer to a purchase history of an associated product than when many purchase histories of an associated product are displayed. Therefore, the customer can use a purchase history of the customer in order to purchase a product in a store.

### Modification Example 2

The terminal 102 may include a storage unit that stores the setting information 111b, and the period setting unit 113 (not illustrated). In this case, the management apparatus 101 may not store the setting information 111b, and may acquire, as necessary, the setting information 111b of a customer who uses the terminal 102 from the terminal 102. Further, the management apparatus 101 may not include the period setting unit 113.

According to the present modification example, the terminal 102 includes the period setting unit 113. Similarly to the example embodiment, the period setting unit 113 acquires a display target period, based on a frequency with which a customer purchases a product belonging to a range defined by associated product defining information, associates the acquired display target period with the associated product defining information, and sets the setting information 111b about the customer.

In this way, the display target period associated with the associated product defining information can be set for each customer. Thus, similarly to the example embodiment, a customer can use a purchase history of the customer in order to purchase a product in a store.

While the example embodiments and the modification examples of the present invention have been described with reference to the drawings, the example embodiments and the modification examples are only exemplification of the present invention, and various configurations other than the above-described example embodiments and modification examples can also be employed.

Further, the plurality of steps (pieces of processing) are described in order in the plurality of flowcharts used in the above-described description, but an execution order of steps performed in each of the example embodiments is not limited to the described order. In each of the example embodiments, an order of illustrated steps may be changed within an extent that there is no harm in context. Further, the example embodiments and the modification examples described above can be combined within an extent that a content is not inconsistent.

A part or the whole of the above-described example embodiments may also be described in supplementary notes below, which is not limited thereto.
1. A management apparatus including:
   a product acquisition means for acquiring, from a terminal of a portable type being operated by a customer in a store, customer identification information for identifying the customer and product identification information about an intended purchase product of the customer;
   a history acquisition means for acquiring a purchase history of an associated product being a product associated with the intended purchase product among purchase histories of the customer, based on purchase history information indicating a purchase history of a product by customer; and
   a history transmission means for transmitting a purchase history of the associated product to the terminal.
2. The management apparatus according to supplementary note 1, wherein
   the history transmission means includes
      a determination means for determining whether a purchase history of the associated product satisfies a predetermined display condition, and
      a target output means for transmitting, to the terminal, a purchase history of the associated product determined to satisfy the display condition.
3. The management apparatus according to supplementary note 2, wherein
   the display condition includes at least one of a condition that a price difference between a purchase price of the associated product and a current price of the intended purchase product is equal to or more than a reference value, a condition that the associated product is purchased within a predetermined display target period, and a condition that a purchase history of the associated product is a latest purchase history of the associated product.
4. The management apparatus according to supplementary note 3, wherein
   the determination means acquires setting information that associates, with the display target period, associated product defining information for defining a range of a product associated with the intended purchase product.
5. The management apparatus according to supplementary note 4, further including
   a period setting means for acquiring the display target period, based on a frequency with which the customer purchases a product belonging to a range defined by the associated product defining information, associating the acquired display target period with the associated product defining information, and setting the setting information about the customer.
6. The management apparatus according to any one of supplementary notes 1 to 5, wherein
   the history transmission means transmits, to the terminal, a purchase history of a simultaneous purchase product being a product purchased together with the associated product.
7. The management apparatus according to any one of supplementary notes 1 to 6, wherein
   the purchase history includes at least one of purchase time, a purchase price, a purchase number, and discount information of the associated product.
8. The management apparatus according to any one of supplementary notes 1 to 7, further including
   a settlement means for performing settlement processing, based on product identification information about the intended purchase product.
9. A terminal of a portable type being operated by a customer in a store, the terminal including:
   a first terminal acquisition means for acquiring customer identification information for identifying the customer;
   a second terminal acquisition means for acquiring product identification information about an intended purchase product of the customer;
   a terminal transmission means for transmitting the customer identification information and the product identification information to a management apparatus;
   a history reception means for receiving, from the management apparatus, a purchase history of an associated product being a product associated with the intended purchase product among purchase histories of the customer; and
   a display control means for displaying a purchase history of the associated product on a display means.
10. The terminal according to supplementary note 9, wherein
   the display control means further displays, on the display means, product information about the intended purchase product.
11. The terminal according to supplementary note 10, wherein
   the display control means simultaneously displays, on the display means, a purchase history of the associated product and product information about the intended purchase product.
12. The terminal according to any one of supplementary notes 9 to 11, further including
   a selection acceptance means for accepting selection of an associated product included in the purchase history, wherein
   the history reception means further receives, from the management apparatus, a purchase history of a simultaneous purchase product being a product purchased together with the associated product, and
   the display control means displays the received purchase history of the simultaneous purchase product on the display means.
13. The management apparatus according to any one of supplementary notes 9 to 12, wherein
   the display control means includes
      a determination means for determining whether a purchase history of the associated product satisfies a predetermined display condition, and
      a target output means for displaying, on the display means, a purchase history of the associated product determined to satisfy the display condition.
14. The management apparatus according to supplementary note 13, wherein
   the display condition includes at least one of a condition that a price difference between a purchase price of the associated product and a current price of the intended purchase product is equal to or more than a reference value, a condition that the associated product is purchased within a predetermined display target period, and a condition that a purchase history of the associated product is a latest purchase history of the associated product.
15. The management apparatus according to supplementary note 14, wherein
the determination means acquires setting information that associates, with the display target period, associated product defining information for defining a range of a product associated with the intended purchase product.
16. The management apparatus according to supplementary note 15, further including
   a period setting means for acquiring the display target period, based on a frequency with which the customer purchases a product belonging to a range defined by the associated product defining information, associating the acquired display target period with the associated product defining information, and setting the setting information about the customer.
17. A purchase history management system including:
   the management apparatus according to any one of supplementary notes 1 to 8; and
   the terminal according to any one of supplementary notes 9 to 16.
18. A management method including,
   by a computer:
   acquiring, from a terminal of a portable type being operated by a customer in a store, customer identification information for identifying the customer and product identification information about an intended purchase product of the customer;
   acquiring a purchase history of an associated product being a product associated with the intended purchase product among purchase histories of the customer, based on purchase history information indicating a purchase history of a product by customer; and
   transmitting a purchase history of the associated product to the terminal.
19. A terminal processing method including,
   by a computer of a portable type being operated by a customer in a store:
   acquiring customer identification information for identifying the customer;
   acquiring product identification information about an intended purchase product of the customer;
   transmitting the customer identification information and the product identification information to a management apparatus;
   receiving, from the management apparatus, a purchase history of an associated product being a product associated with the intended purchase product among purchase histories of the customer; and
   displaying a purchase history of the associated product on a display means.
20. A program for causing a computer to execute:
   acquiring, from a terminal of a portable type being operated by a customer in a store, customer identification information for identifying the customer and product identification information about an intended purchase product of the customer;
   acquiring a purchase history of an associated product being a product associated with the intended purchase product among purchase histories of the customer, based on purchase history information indicating a purchase history of a product by customer; and
   transmitting a purchase history of the associated product to the terminal.
21. A program for causing a computer of a portable type being operated by a customer in a store to execute:
   acquiring customer identification information for identifying the customer;
   acquiring product identification information about an intended purchase product of the customer;
   transmitting the customer identification information and the product identification information to a management apparatus;
   receiving, from the management apparatus, a purchase history of an associated product being a product associated with the intended purchase product among purchase histories of the customer; and
   displaying a purchase history of the associated product on a display means.
100 Purchase history management system
101 Management apparatus
102 Terminal
111 Storage unit
111a Product information
111b Setting information
111c Purchase history information
112 Associated product setting unit
113 Period setting unit
121 Product acquisition unit
122 History acquisition unit
123 History transmission unit
124 Settlement unit
125 History transmission unit
131 Determination unit
132 Target output unit
141 Associated product specification unit
142 Period specification unit
151 First terminal acquisition unit
152 Second terminal acquisition unit
153 Terminal transmission unit
154 Product information reception unit
161 History reception unit
162 Display control unit
163 Display unit
164 Selection acceptance unit
165 Deletion acceptance unit
166 Settlement acceptance unit

1. A management apparatus comprising:
at least one memory configured to store instructions; and
at least one processor configured to execute the instructions to perform operations comprising:
acquiring, from a terminal of a portable type being operated by a customer in a store, customer identification information for identifying the customer and product identification information about an intended purchase product of the customer;
acquiring a purchase history of an associated product being a product associated with the intended purchase product among purchase histories of the customer, based on purchase history information indicating a purchase history of a product by customer; and
transmitting the purchase history of the associated product to the terminal.

2. The management apparatus according to claim 1, wherein
transmitting the purchase history includes
determining whether the purchase history of the associated product satisfies a predetermined display condition, and
transmitting, to the terminal, the purchase history of the associated product determined to satisfy the display condition.

3. The management apparatus according to claim 2, wherein
the display condition includes at least one of a condition that a price difference between a purchase price of the associated product and a current price of the intended purchase product is equal to or more than a reference value, a condition that the associated product is purchased within a predetermined display target period, and a condition that the purchase history of the associated product is a latest purchase history of the associated product.

4. A terminal of a portable type being operated by a customer in a store, the terminal comprising:
at least one memory configured to store instructions; and
at least one processor configured to execute the instructions to perform operations comprising:
acquiring customer identification information for identifying the customer;
acquiring product identification information about an intended purchase product of the customer;
transmitting the customer identification information and the product identification information to a management apparatus;
receiving, from the management apparatus, a purchase history of an associated product being a product associated with the intended purchase product among purchase histories of the customer; and
displaying the purchase history of the associated product on a display.

5. The terminal according to claim 4, wherein
displaying the purchase history includes simultaneously displaying, on the display, the purchase history of the associated product and product information about the intended purchase product.

6. The terminal according to claim 4, further comprising
accepting selection of the associated product included in the purchase history,
receiving, from the management apparatus, a purchase history of a simultaneous purchase product being a product purchased together with the associated product, and
displaying the received purchase history of the simultaneous purchase product on the display.

7. A management method comprising,
by a computer:
acquiring, from a terminal of a portable type being operated by a customer in a store, customer identification information for identifying the customer and product identification information about an intended purchase product of the customer;
acquiring a purchase history of an associated product being a product associated with the intended purchase product among purchase histories of the customer, based on purchase history information indicating a purchase history of a product by customer; and
transmitting the purchase history of the associated product to the terminal.
